(19) United States
(12) Patent Application Publication
(10) Pub. No.: US 2026/0210137 A1
(43) Pub. Date: Jul. 23, 2026

(54) MOBILE LARGE-SCALE THREE-DIMENSIONAL CONSTRUCTION PRINTING SYSTEM WITH PRECISION MOTION CONTROL

(71) Applicant: James Ritter, Wellington, FL (US)

(72) Inventor: James Ritter, Wellington, FL (US)

(21) Appl. No.: 19/458,678

(22) Filed: Jan. 23, 2026

Related U.S. Application Data
(60) Provisional application No. 63/963,459, filed on Jan. 19, 2026.
(60) Provisional application No. 63/963,246, filed on Jan. 19, 2026.
(60) Provisional application No. 63/748,948, filed on Jan. 23, 2025.

(51) Int. Cl. E04G 21/04; B33Y 30/00; B33Y 40/00

(52) U.S. Cl. CPC E04G 21/0463; B33Y 30/00; B33Y 40/00

(57) ABSTRACT

A mobile large-scale three-dimensional construction printing system is disclosed that integrates a maneuverable construction machine platform with a boom-mounted material delivery and precision motion control architecture. The system includes a base platform having a rotatable superstructure and a telescoping boom, a bulk material storage container, a conveyor extending along the boom for conveying dry construction material, a mixer head positioned proximal to a print nozzle, and a print nozzle configured to extrude printable material in successive layers. A motion control system incorporates a reduction gearbox, backlash control assembly, bias drive, position feedback sensors, and coordinated kinematic control to provide accurate multi-axis positioning suitable for additive manufacturing.

### CROSS-REFERENCE TO RELATED APPLICATIONS

This application claims the benefit under 35 U.S.C. §119(e) of U.S. Provisional Patent Application No. 63/748,948, filed January 23, 2025, entitled “A Three-Dimensional Construction Printing System”; U.S. Provisional Patent Application No. 63/963,246, filed January 19, 2026, entitled “Telehandler-Based Large-Scale 3D Printing System”; and U.S. Provisional Patent Application No. 63/963,459, filed January 19, 2026, entitled “Components of a Telehandler-Based Large-Scale 3D Printing System,” each of which is hereby incorporated by reference in its entirety.

### FIELD OF THE INVENTION

This invention relates to the field of construction technology, particularly to systems and methods for automated three-dimensional construction printing using mobile and adaptable construction machinery integrated with advanced material delivery systems, precision control, and innovative printing technologies.

### BACKGROUND

Current three-dimensional construction printing systems include gantry and rail systems for delivering construction material to the print head. Typically, these systems rely on pumps and hoses to transport mixed concrete or other materials over significant distances from the mixing station to the print head. However, this setup introduces several limitations, including material degradation due to pressure changes, inconsistent rheology, significant material waste, and extended setup and cleanup times.

The use of pumps and hoses in traditional three-dimensional construction printing systems introduces numerous challenges. Pumps subject the material to inconsistent pressure, leading to fluctuations in flow and affecting the quality of the print. Additionally, hoses often experience blockages, wear, and material buildup, causing delays and requiring extensive maintenance. These problems contribute to operational inefficiencies and can compromise the structural integrity of printed components.

Material handling inefficiencies further exacerbate these issues. In current systems, large volumes of material must be mixed to fill the hoses, even for smaller print tasks. This approach results in significant waste when unused material hardens in the lines. Cleanup is labor-intensive, often taking hours, and the disposal of unused material adds to costs and environmental concerns.

Traditional gantry and rail systems also pose significant logistical challenges. These systems require substantial site preparation, including the construction of fixed supports and tracks, which can take several days to assemble and align before printing can begin. Their fixed nature limits mobility and adaptability, making them unsuitable for complex or large-scale construction projects that require frequent relocation or adjustments to the printing area.

Another critical limitation is the inability of current systems to effectively address interruptions or changes in the printing process. When a print is paused or errors occur, significant recalibration and waste of material are often required. Current systems also lack the capability to resume printing precisely from the point where it was stopped, leading to inefficiencies and delays.

Current three-dimensional construction printing setups have yet to effectively integrate advanced mobility and control technologies, such as GPS and automated software systems. While such technologies are widely available, their absence in existing systems hinders precise positioning, print continuity, and operational efficiency. This gap limits the ability of operators to streamline setup, adjust for environmental factors, and recover from interruptions without extensive manual intervention.

Furthermore, existing three-dimensional construction printing systems are designed as bespoke printing solutions, limiting their versatility and cost-effectiveness. The use of specialized machinery for printing alone increases upfront costs and reduces the utility and resale value of the equipment compared to multipurpose construction machines.

Thus, a need exists in the market for a mobile, efficient, and integrated three-dimensional construction printing system that minimizes material waste, reduces setup and cleanup times, improves the rheology and consistency of printed materials, and enhances adaptability through advanced software and mobility technologies. Such a system should address the inherent limitations of pumps and hoses, simplify operations, and offer the versatility of converting between a construction machine and a 3D printer.

### SUMMARY OF THE INVENTION

The present invention provides a mobile, telehandler-based three-dimensional construction printing system that addresses the inefficiencies and limitations of conventional pump-and-hose or fixed gantry systems. By fitting a telehandler with a modular material delivery assembly, integrated mixing chamber, and precision-controlled nozzle, the system enables efficient, on-site additive manufacturing of large-scale structures. Dry material is stored in a compact, transportable silo mounted to the telehandler and conveyed via augers to the mixing chamber located proximal to the print head, preserving optimal rheology and reducing waste. The mobile nature of the telehandler platform eliminates the need for extensive site preparation, allows rapid relocation, and supports printing over large or complex work areas without fixed tracks or supports.

The system further integrates advanced motion control, backlash compensation, GPS-based positioning, and custom kinematic software to deliver precise, repeatable deposition of structural materials in successive layers. Closed-loop feedback from encoders and displacement transducers ensures consistent nozzle positioning, while hydraulic and electronic retrofits provide smooth, servo-governed motion in all axes. The design facilitates fast setup, efficient cleanup, and high adaptability, enabling the telehandler to be quickly converted between a standard construction machine and a three-dimensional construction printer. These features result in reduced operational costs, minimized downtime, and improved print quality, offering a versatile and scalable solution for large-scale three-dimensional construction printing.

The invention disclosed herein provides a three-dimensional construction printing system. The three-dimensional construction printing system comprises a base platform comprising a construction machine having a rotatable superstructure and a telescoping boom, a material delivery assembly mounted to the rotatable superstructure of the base platform, and a print nozzle fluidly coupled to the mixer head and configured to extrude the printable material to form successive layers of a structure. The material delivery assembly mounted to the rotatable superstructure of the base platform comprises a bulk material storage container configured to store dry construction material, a conveyor extending along the boom and configured to convey the dry construction material from the storage container toward a distal end of the boom, and a mixer head positioned proximal to a print nozzle and configured to receive the dry construction material and mix the dry construction material with a liquid to form printable material.

The invention disclosed herein further provides a method of providing a mobile three-dimensional construction printing system. The method comprises the steps of providing a mobile construction platform having a rotatable superstructure and an extendable boom, mounting a bulk material storage container to the mobile construction platform, mounting a conveyor along the boom configured to convey dry construction material toward a distal end of the boom, providing a mixer head positioned proximal to a print nozzle and configured to mix dry construction material with a liquid to form printable material, coupling the print nozzle to the mixer head, coupling a reduction gearbox to an azimuth rotation axis of the mobile construction platform, providing a backlash control assembly configured to preload a drivetrain of the azimuth rotation axis, providing a bias drive configured to apply a substantially constant torque to the azimuth rotation axis, installing position feedback sensors comprising at least one encoder and at least one linear displacement transducer, and providing a control system configured to override native control logic of the mobile construction platform and to generate coordinated kinematic commands for controlling azimuth rotation, boom extension, boom elevation, and payload leveling.

It is an object of the present invention to provide a mobile three-dimensional construction printing system capable of positioning a print head throughout a large three-dimensional work envelope without fixed gantries, rails, or external supports.

It is yet another object of the present invention is to provide a to provide a construction-machine-based printing system having a precision motion and control architecture capable of accurate, repeatable multi-axis positioning suitable for layer-by-layer deposition of structural material.

It is a further object to provide a to provide an integrated material delivery and on-demand mixing system that preserves material rheology, reduces waste, and enables efficient setup, operation, and cleanup during large-scale additive manufacturing.

It is additionally another object of the present invention to enable interruption, repositioning, and resumption of printing operations with maintained positional fidelity.

It is yet another object of the present invention is to synchronize nozzle motion with material delivery and extrusion to maintain consistent bead geometry and structural integrity during printing operations.

The drawings and specific descriptions of the drawings, as well as any specific or alternative embodiments discussed, are intended to be read in conjunction with the entirety of this disclosure. The invention may be embodied in many different forms and should not be construed as being limited to the embodiments set forth herein; rather, these embodiments are provided by way of illustration only and so that this disclosure will be thorough, complete and fully convey understanding to those skilled in the art. The above and yet other objects and advantages of the present invention will become apparent from the hereinafter set forth Brief Description of the Drawings, Detailed Description of the Invention, and Claims appended herewith.

### BRIEF DESCRIPTION OF THE DRAWINGS

FIG. 1 illustrates a front perspective view of the three-dimensional construction printing system.

FIG. 2 illustrates a front perspective view of the three-dimensional construction printing system, with an isolated enlarged view of the bias drive installed in the rotatable superstructure.

FIG. 3 illustrates an isolated isometric view of the bias drive.

FIG. 4 illustrates a cross-section view of the bias drive shown in FIG. 3.

FIG. 5 illustrates a front perspective view of a telehandler with a belt-style conveyor affixed to the top of the extendable boom.

FIG. 6 illustrates an isolated front right-side perspective view of the belt-style conveyor affixed to the top of the telescoping boom.

FIG. 7 illustrates an isolated front left-side perspective view of the belt-style conveyor affixed to the top of the telescoping boom.

FIG. 8 illustrates an isolated rear right-side perspective view of the belt-style conveyor affixed to the top of the telescoping boom, in an extended state.

FIG. 9 illustrates a front isometric view of the mixer system and print head.

FIG. 10 illustrates a front view of the mixer system and print head.

FIG. 11 illustrates a cross-section view of the mixer system and print head, at section cut A-A of FIG. 10.

FIG. 12 illustrates an isometric view of the nozzle assembly of the print head.

FIG. 13 illustrates a cross-section view of the nozzle assembly of the print head.

FIG. 14 illustrates a block diagram of the control system.

FIG. 15 illustrates a conceptual view of sensor placement on the three-dimensional construction printing system, showing exemplary locations of position feedback sensors disposed on the boom, payload, and azimuth rotation axis, a hydraulic actuator, a control system, and communication paths for closed-loop multi-axis motion control.

FIG. 16 illustrates a front isometric view of the three-dimensional construction printing system illustrating exemplary kinematic degrees of freedom of the base platform and boom for positioning the print nozzle.

FIG. 17 illustrates a conceptual top plan view of the three-dimensional construction printing system illustrating a building floor plan, site reference points, and telehandler reference points for position tracking and alignment of the print nozzle relative to a print job.

FIG. 18 illustrates a side view of the boom, print head, and telehandler of the system, with angulated changes shown in dashed lines.

FIG. 19 illustrates a flow diagram of a method of providing a mobile three-dimensional construction printing system.

FIG. 20 illustrates a flow diagram of additional steps in the method of providing a mobile three-dimensional construction printing system.

FIG. 21 illustrates a flow diagram of additional steps in the method of providing a mobile three-dimensional construction printing system

FIG. 22 illustrates a flow diagram of the step of providing a control system.

### DETAILED DESCRIPTION OF THE INVENTION

The present invention relates generally to large-scale additive manufacturing in the field of construction, and more particularly to a mobile three-dimensional construction printing system that integrates a conventional construction machine platform with a material delivery assembly, an on-demand mixing and extrusion system, and a precision motion and control architecture configured to enable accurate, repeatable deposition of structural material over large work areas.

Conventional three-dimensional construction printing systems are predominantly implemented using fixed gantry structures, rail-based systems, or stationary robotic frames that position a print head relative to a prepared build area. While such systems can provide controlled motion in limited envelopes, they typically require extensive site preparation, fixed supports, tracks, and alignment procedures, and are inherently constrained in reach, scalability, and adaptability to complex or evolving construction environments. In addition, many conventional systems rely on pump-and-hose delivery architectures in which premixed material is transported over substantial distances to the print head, introducing pressure fluctuations, rheological degradation, material waste, and lengthy setup and cleanup cycles.

The present invention addresses these limitations by providing a mobile, self-contained construction printing platform based upon a maneuverable construction machine having a rotatable superstructure and an extendable boom. In particular embodiments, a telehandler or similar machine serves as a base platform, providing a stable mobile chassis, a rotating turret, and a multi-axis articulated boom capable of positioning a print head throughout a large three-dimensional work envelope without fixed tracks, rails, or external supports. The mobility and reach of the base platform enable printing over large or irregular building sites, rapid repositioning, and access to complex geometries that are impractical for stationary gantry-based systems.

However, conventional construction machines are not designed to provide the positional precision, smooth low-speed motion, and repeatability required for layer-by-layer additive manufacturing of structural components. Typical telehandlers and similar machines are optimized for load handling, lifting, and placement operations, and exhibit substantial mechanical play, hydraulic compliance, drivetrain backlash, and oscillatory behavior that preclude accurate deposition of material with consistent layer height, bead width, and geometric fidelity. Accordingly, the present invention further provides a coordinated set of mechanical, electronic, and software subsystems that transform a conventional construction machine into a precision-controlled additive manufacturing platform.

In one aspect, the invention provides an integrated material delivery assembly mounted to the boom of the base platform. The material delivery assembly includes a bulk storage container configured to store dry construction material, and a conveyor extending along the boom and configured to convey the dry material toward a distal end of the boom. By conveying dry material directly along the boom, the system eliminates long hose runs and remote pumping of premixed material, thereby preserving rheological properties, reducing pressure-induced degradation, and minimizing waste. In preferred embodiments, the conveyor may comprises an auger-based or tube-based conveyor that extends and retracts with the boom to maintain continuous material flow as the boom length changes. In other embodiments, the conveyor is a belt conveyor that extends and retracts with the boom to maintain continuous material flow as the boom length changes.

At or near the distal end of the boom, the invention provides a mixer head assembly positioned proximal to a print nozzle. The mixer head is configured to receive the conveyed dry material and to mix the dry material with a liquid to form printable material immediately prior to extrusion. By performing mixing on demand at the print head, the system avoids prolonged residence times, prevents premature setting within hoses, and allows precise control over material consistency at the point of deposition. The mixer head may include one or more feed augers and mixing augers driven by hydraulic or electric motors, and may be constructed as a modular assembly to facilitate maintenance, cleaning, and reconfiguration.

The printable material produced by the mixer head is delivered directly to a print nozzle fluidly coupled to the mixer head. The print nozzle is configured to extrude the material in successive layers to form walls, shells, or other structural features of a building or large-scale structure. The nozzle geometry and extrusion parameters may be selected to control bead width, layer height, and interlayer bonding in accordance with structural and architectural requirements.

To enable accurate positioning of the print nozzle throughout the build volume, the invention further provides a motion control system configured to govern coordinated multi-axis movement of the base platform and boom. In particular embodiments, the motion control system controls at least an azimuth rotation axis of the superstructure, a boom extension axis, a boom elevation axis, and a payload leveling axis. Position feedback sensors, including at least one rotary encoder and at least one linear displacement transducer, are mounted to the machine to provide continuous measurement of joint positions and boom geometry.

In order to achieve the positional resolution and stability required for additive manufacturing, the invention further incorporates a drivetrain refinement architecture for the azimuth rotation axis. A reduction gearbox is coupled to the azimuth axis to increase torque and angular resolution. A backlash control assembly is configured to preload the drivetrain to reduce or eliminate mechanical slack between mating gear teeth. A bias drive applies a substantially constant torque to the azimuth axis to maintain continuous gear tooth engagement and suppress oscillation during low-speed motion and direction reversals. Together, these subsystems convert the inherently compliant and discontinuous motion of a heavy construction drivetrain into a smooth, high-resolution rotational axis suitable for precise tool positioning.

The invention further provides a control system operatively coupled to the motion control system and configured to override native control logic of the construction machine. In preferred embodiments, a programmable logic controller converts toolpath instructions into coordinated kinematic commands, and a motion controller generates real-time control signals to hydraulic valves governing each controlled axis. Communication between the control system and the machine actuators may be provided through a digital communication bus or equivalent interface. Closed-loop servo control is employed to continuously compare commanded positions with measured positions and to adjust valve actuation accordingly, thereby compensating for hydraulic variability, load changes, and mechanical compliance.

By integrating the mobile base platform, the boom-mounted material delivery assembly, the on-demand mixing and extrusion system, and the precision motion and control architecture, the present invention provides a mobile three-dimensional construction printing system capable of depositing structural material accurately and repeatably over large work envelopes without fixed gantries, rails, or external supports. The system enables rapid setup, reduced site preparation, minimized material waste, and the ability to reposition, interrupt, and resume printing operations with high positional fidelity. The resulting platform combines the mobility and reach of a construction machine with the precision and control of an industrial robotic printer, providing a scalable and adaptable solution for large-scale additive manufacturing in construction environments.

In some embodiments, the construction three-dimensional printer system is formed by retrofitting a construction machine, such as a telehandler, with mechanical, electronic, and software modifications to enable controlled deposition of building materials.

Regarding mechanical modifications, the telehandler’s structural geometry is modeled in 3D CAD to permit integration of retrofit components. A material delivery system, including a bulk hopper mounted to the boom, is configured to convey printable material to a nozzle at the boom’s distal end.

Regarding motion control integration, the system interfaces with the telehandler’s hydraulic and electronic systems via the CAN bus, enabling independent servo control of each axis of motion. A PID servo loop governs actuation of the hydraulic valves for telescoping, azimuth rotation, boom elevation, and payload leveling.

Regarding position feedback, absolute encoders are installed on the telescoping and azimuth axes for closed-loop control. Linear displacement transducers measure boom elevation and payload leveling positions. Encoder mounts are integrated into the boom and azimuth structures.

Regarding backlash compensation, an azimuth backlash compensation assembly includes a hydraulic motor and reduction gearing to preload the drivetrain,

eliminating play and increasing position control authority. A reduction gearbox in the azimuth drive provides approximately 23× improvement in resolution, enabling precise, repeatable low-speed motion.

Regarding software and kinematics, custom kinematics and slicing software simulate the modified telehandler’s motion in a 3D printing environment and generate toolpaths for constructing walls layer-by-layer. The software coordinates with the servo control system to execute precise nozzle positioning during material deposition.

Regarding intended operation, in use, the telehandler positions the nozzle along predetermined paths to deposit building material in successive layers, forming structural walls of a building. The backlash-compensated azimuth drive, telescoping control, and integrated feedback systems maintain precise tool positioning throughout the build process.

In some embodiments, the coordinated operation of the motion control system and the material delivery system enables continuous deposition of material while the boom executes multi-axis motion, such that nozzle position, material flow rate, and layer geometry are synchronized throughout the build process.

Regarding the mixer head and related systems, the mixer head assembly is a material delivery head configured for integration with a large-scale additive manufacturing apparatus. The head comprises a feed auger and a mixing auger arranged to convey and homogenize printable construction material prior to extrusion. The mixing auger has been sized at approximately four inches in diameter, as smaller diameters, such as three inches, were found insufficient to achieve the desired mixing performance. The auger system is designed to deliver material at flow rates up to approximately ten inches per second, providing operational overhead for prototyping.

Production systems may employ smaller augers or lower flow rates once power requirements are optimized.

The augers are driven by electric or hydraulic motors coupled through quick-release couplers to facilitate maintenance and replacement. The mixer head assembly may employ V-band style couplers to join modular sections. In one embodiment, the empty system weighs approximately 400 pounds, though weight may vary depending on material choice, auger length, and housing dimensions.

Regarding silo configuration, the storage silo is configured with an elongated profile to reduce height, facilitating stability and transport. A volume capacity of approximately two to three cubic yards is maintained. The augers within the silo may be arranged in layered fashion without spacing between them, lowering the profile while maintaining feed efficiency. The silo may be approximately three feet in width, and the top section may be hinged to permit loading from bulk super sacks. A secondary, smaller hatch within the larger lid can allow for direct auger filling.

Regarding telehandler retrofit for 3D printing, the mixer head and silo may be mounted to the boom of a telehandler that has been modified for additive manufacturing. Modifications include mechanical adaptors, drive systems, and control hardware/software to position the delivery head with precision in three dimensions. The system includes a gear train configured to provide controlled azimuth rotation of the boom, incorporating an encoder for feedback and a backlash control mechanism.

Regarding the backlash control assembly, a backlash control assembly may employ a hydraulic motor or piston applying approximately 120–150 pounds of force to preload the azimuth drivetrain, eliminating mechanical play and enabling precise positioning. This may be augmented with a bias drive applying approximately 200 ft-lbs of torque to the rotation axis. The bias drive may also integrate encoder feedback for closed-loop positional control.

Regarding the gearbox and bias drive, the azimuth drive may incorporate a reduction gearbox to increase torque and positional resolution. The bias drive may be configured to maintain constant load against gear teeth, preventing oscillation or delay during fine positional adjustments.

Regarding the extendable tube conveyor, in some embodiments, a tube conveyor may be mounted along the telehandler boom for material transport. The conveyor may extend and retract with boom sections and may utilize a flat return path. This design allows for direct material delivery from the silo to the mixer head without requiring fixed-length conduits.

In some embodiments, the system includes a main cabinet and a control panel: the cabinet houses a motion controller that serves as the primary network hub and commands all valve movement, an Ethernet switch linking the programmable logic controller, motion controller, and control panels, a programmable logic controller that converts machine instruction files into kinematic commands for the motion controller, relays and contactors for cabinet power, relays for switching control signals to the amplifiers, an industrial fieldbus amplifier that sends control voltage to the valves, and a 24V battery with an associated charger, with capacity to expand for additional wiring; the control panel includes a 10-inch touchscreen interface, two rotary knobs for adjusting feed speed and material delivery flow, an override button to permit direct manual input, and a separate keyswitch panel near the machine ignition that must be actuated prior to startup to enable valve signal switching without power applied.

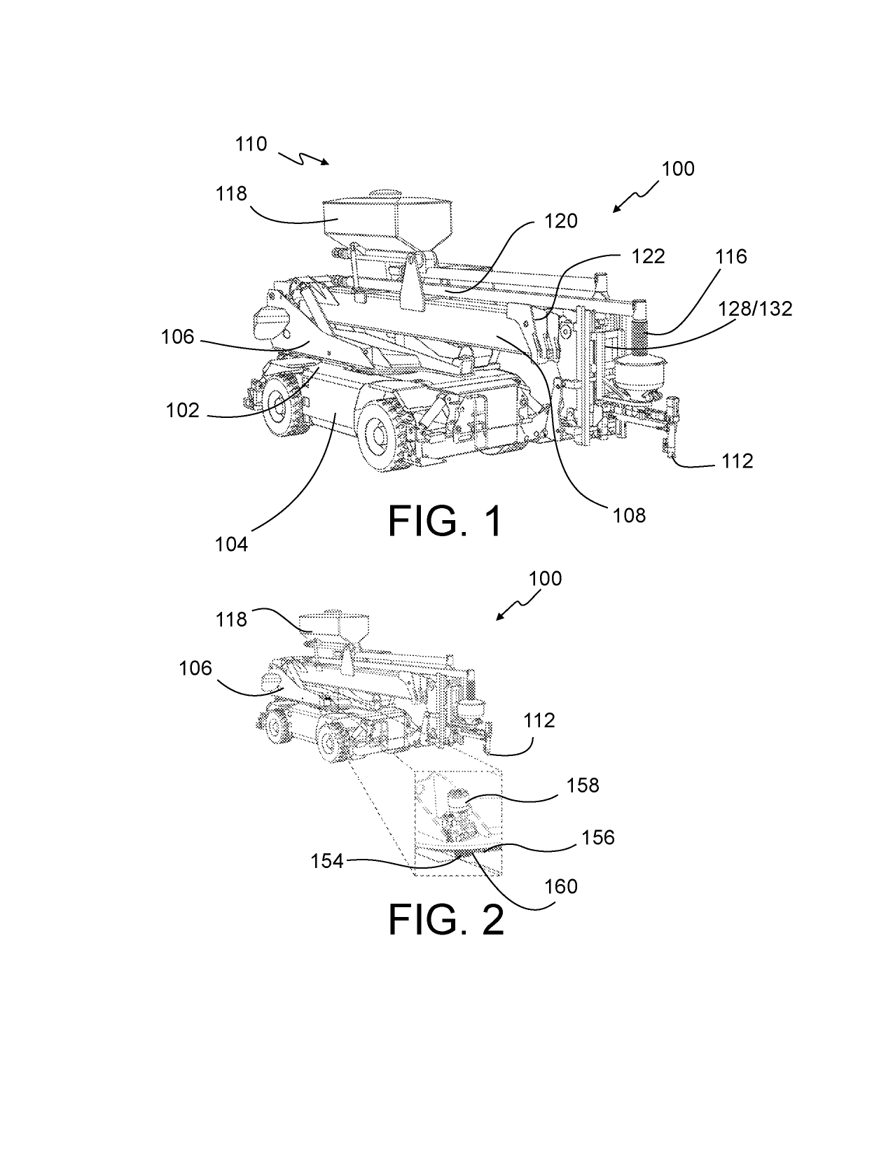

The mobile large-scale three-dimensional construction printing system with precision motion control of the present invention may be used to position a print head throughout a large three-dimensional work envelope without fixed gantries, rails, or external supports, to achieve precision-controlled multi-axis motion suitable for accurate and repeatable layer-by-layer deposition of structural material, to convey, mix, and extrude construction material on demand with preserved rheological properties and reduced waste, to permit interruption, repositioning, and resumption of printing operations with maintained positional fidelity, and to synchronize nozzle motion with material delivery to maintain consistent bead geometry and structural integrity during printing operations. This apparatus and system are particularly shown in FIGS. 1-22.

FIG. 1 illustrates a front perspective view of the three-dimensional construction printing system 100, comprising a base platform 102 including a construction machine 104 having a rotatable superstructure 106 and a telescoping boom 108. A material delivery assembly 110 is mounted to the rotatable superstructure 106 and includes a bulk material storage container 118 and a conveyor 120 extending along the boom 108 toward a distal end 122 of the boom 108. A mixer tube 116 and a vertical adjustment mechanism 128 having a securement carriage 132 are positioned at the distal end 122 of the boom 108. A print nozzle 112 is coupled to the mixer tube 116 and is configured to extrude printable material for forming successive layers of a structure.

FIG. 2 illustrates a front perspective view of the three-dimensional construction printing system 100, with an isolated enlarged view of a portion of the rotatable superstructure 106 illustrating a bias drive 158, a backlash control assembly 154, and a drivetrain 156 associated with an azimuth rotation axis. The isolated view further illustrates gear tooth engagement 160 between mating gear elements of the

drivetrain 156, whereby the backlash control assembly 154 is configured to preload the drivetrain 156 and the bias drive 158 is configured to apply a constant torque to maintain the gear tooth engagement 160 and suppress oscillation during rotation of the rotatable superstructure 106.

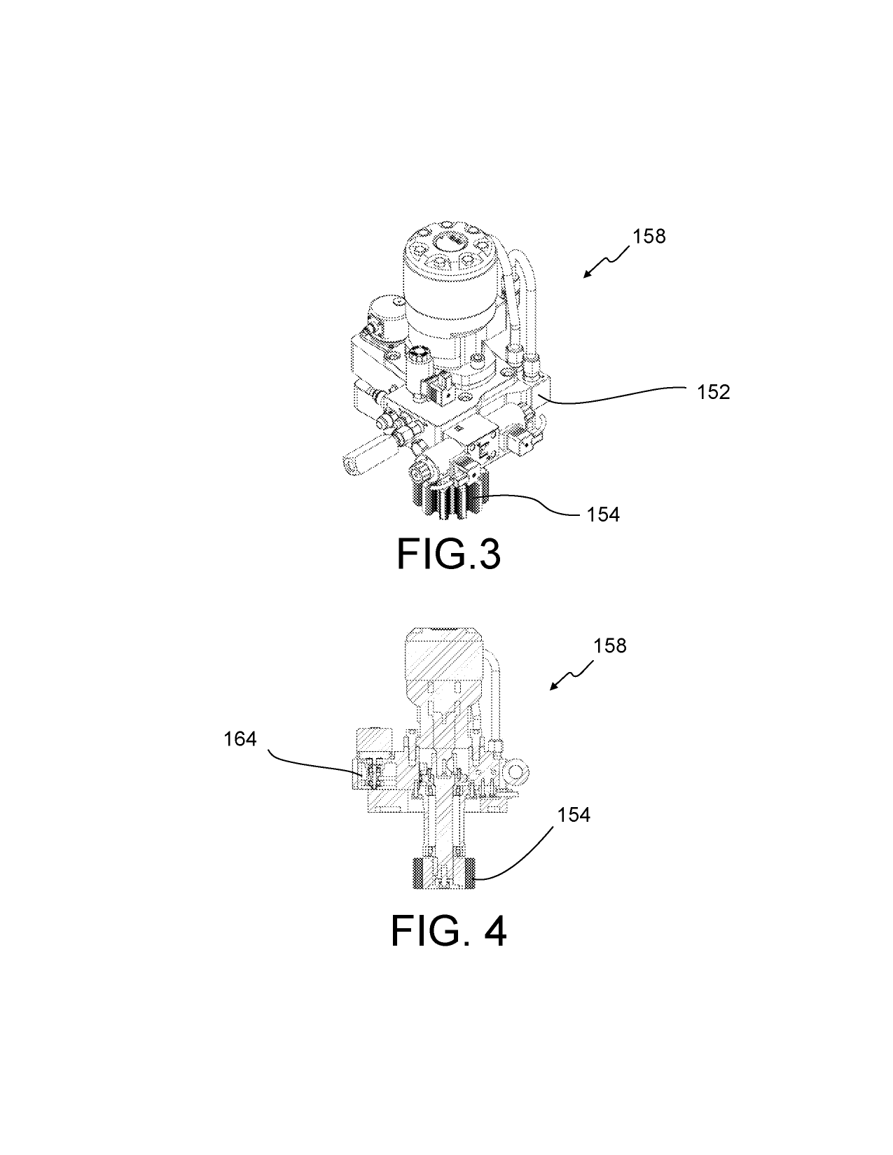

FIG. 3 illustrates an isolated isometric view of the bias drive 158, including a reduction gearbox 152 and a backlash control assembly 154 coupled thereto, the bias drive 158 being configured to apply a constant torque through the reduction gearbox 152 to preload a drivetrain and maintain gear tooth engagement during rotation of the rotatable superstructure.

FIG. 4 illustrates a cross-sectional view of the bias drive 158 shown in FIG. 3, further illustrating an encoder 164 and a backlash control assembly 154 disposed within the bias drive 158 for monitoring rotational position and preloading a drivetrain to maintain gear tooth engagement during operation.

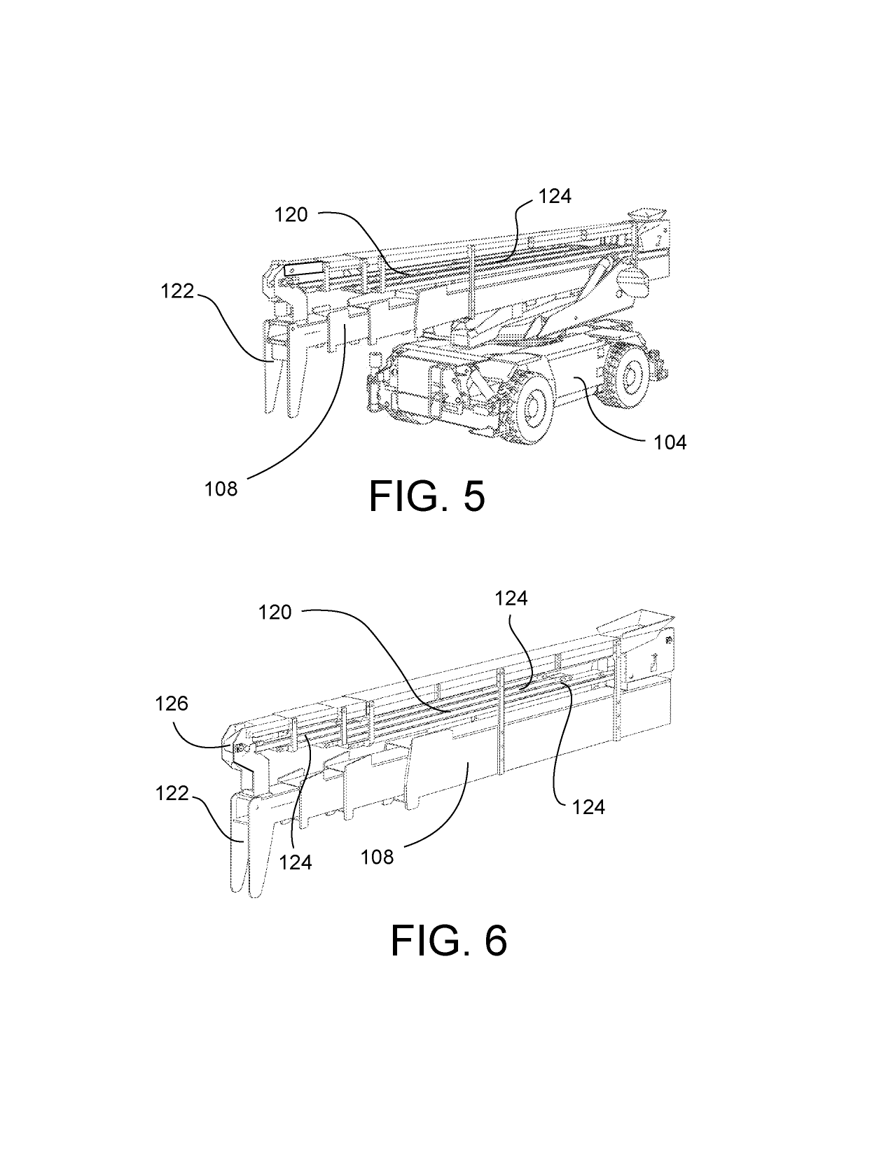

FIG. 5 illustrates a front perspective view of a construction machine 104 having a telescoping boom 108 and a belt-style conveyor 120 mounted along the boom 108, the conveyor 120 comprising multiple conveyor segments 124 configured to extend and retract with the boom 108 to convey material toward a distal end 122 of the boom 108.

FIG. 6 illustrates an isolated front right-side perspective view of a conveyor 120 mounted along a telescoping boom 108, the conveyor 120 comprising multiple conveyor segments 124 and a belt-style conveyor track 126 configured to extend and retract with the boom 108 and to convey material toward a distal end 122 of the boom 108.

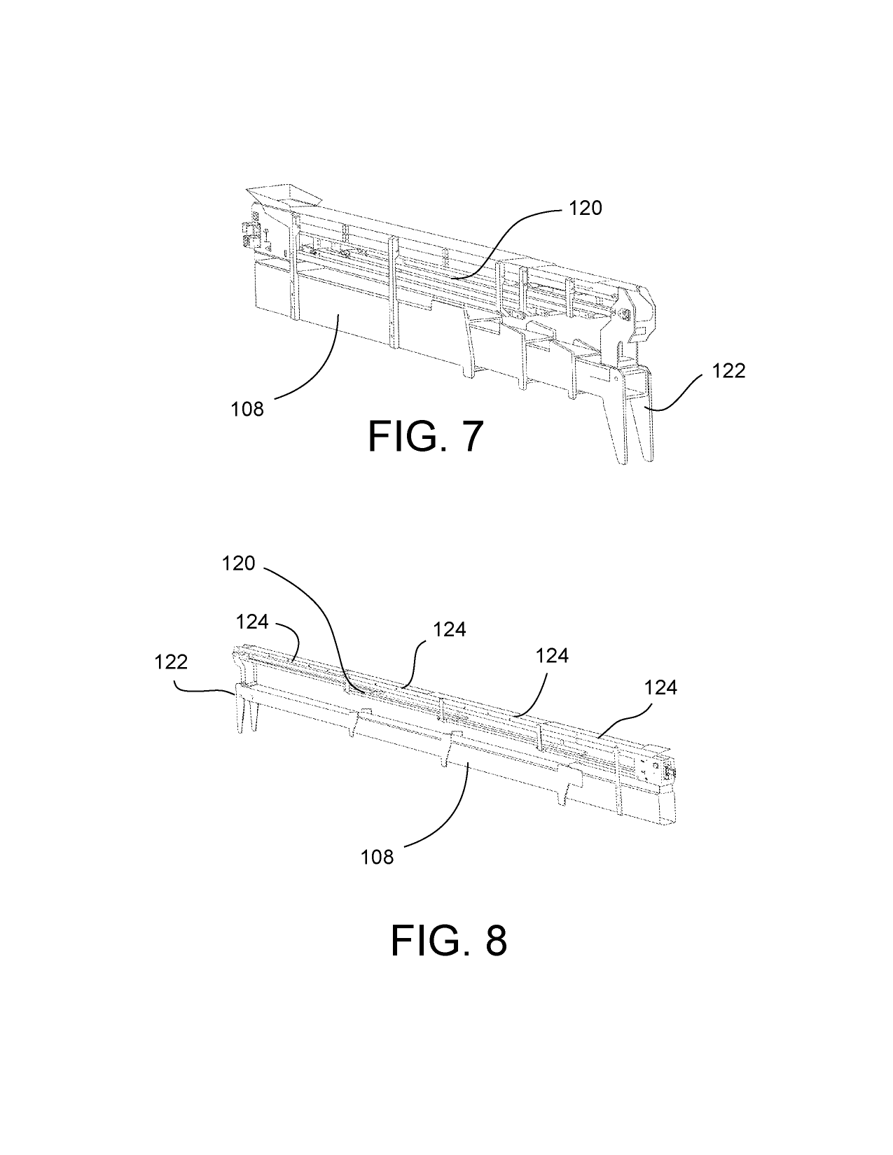

FIG. 7 illustrates an isolated front left-side perspective view of a conveyor 120 mounted along a telescoping boom 108 and extending toward a distal end 122 of the boom 108.

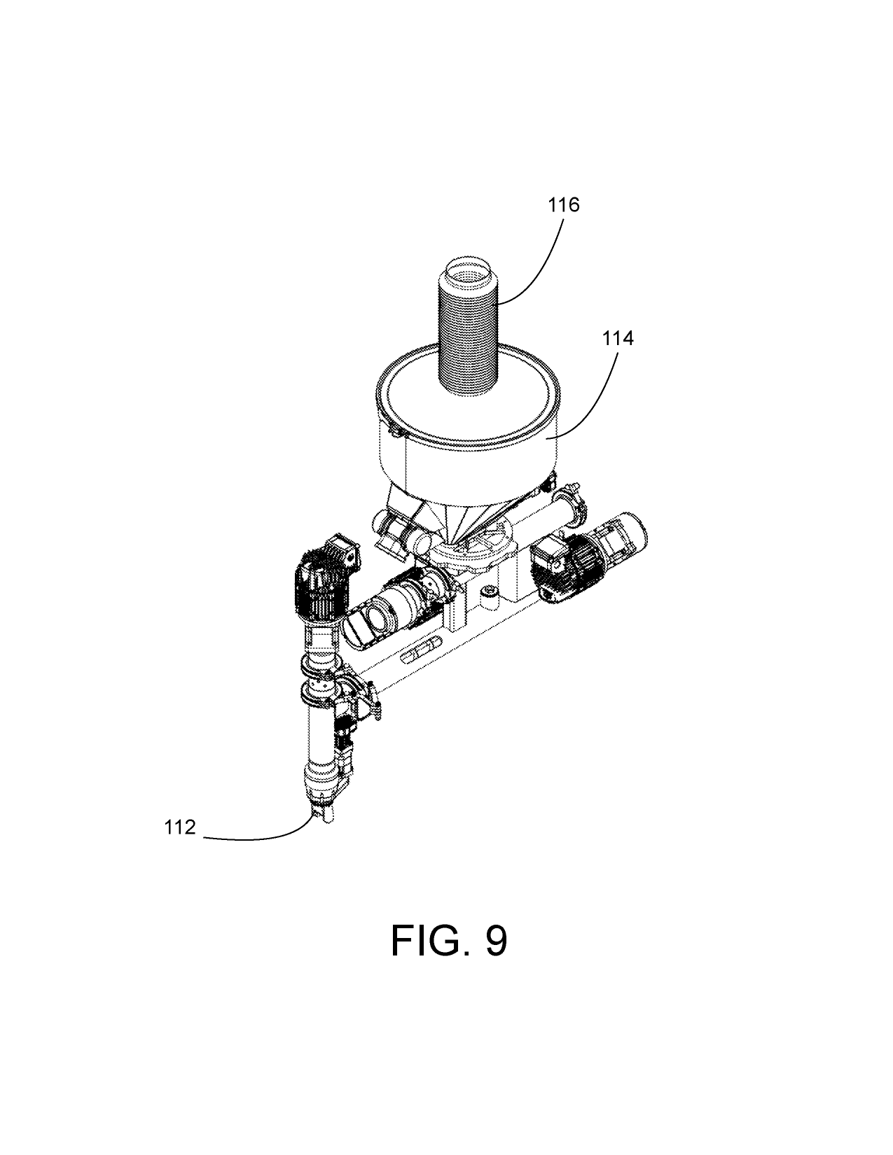

FIG. 8 illustrates an isolated rear right-side perspective view of a conveyor 120 mounted along a telescoping boom 108 and comprising multiple conveyor segments 124, the conveyor 120 being shown in an extended state and extending toward a distal end 122 of the boom 108.

FIG. 9 illustrates a front isometric view of a mixer head 114, a mixer tube 116, and a print nozzle 112 forming a material mixing and extrusion assembly configured to receive dry construction material, mix the dry construction material with a liquid, and extrude printable material through the print nozzle 112. The mixer tube is extendable to allow the mixer contents to empty from the conveyor into the tube and be guided in to the mixing chamber.

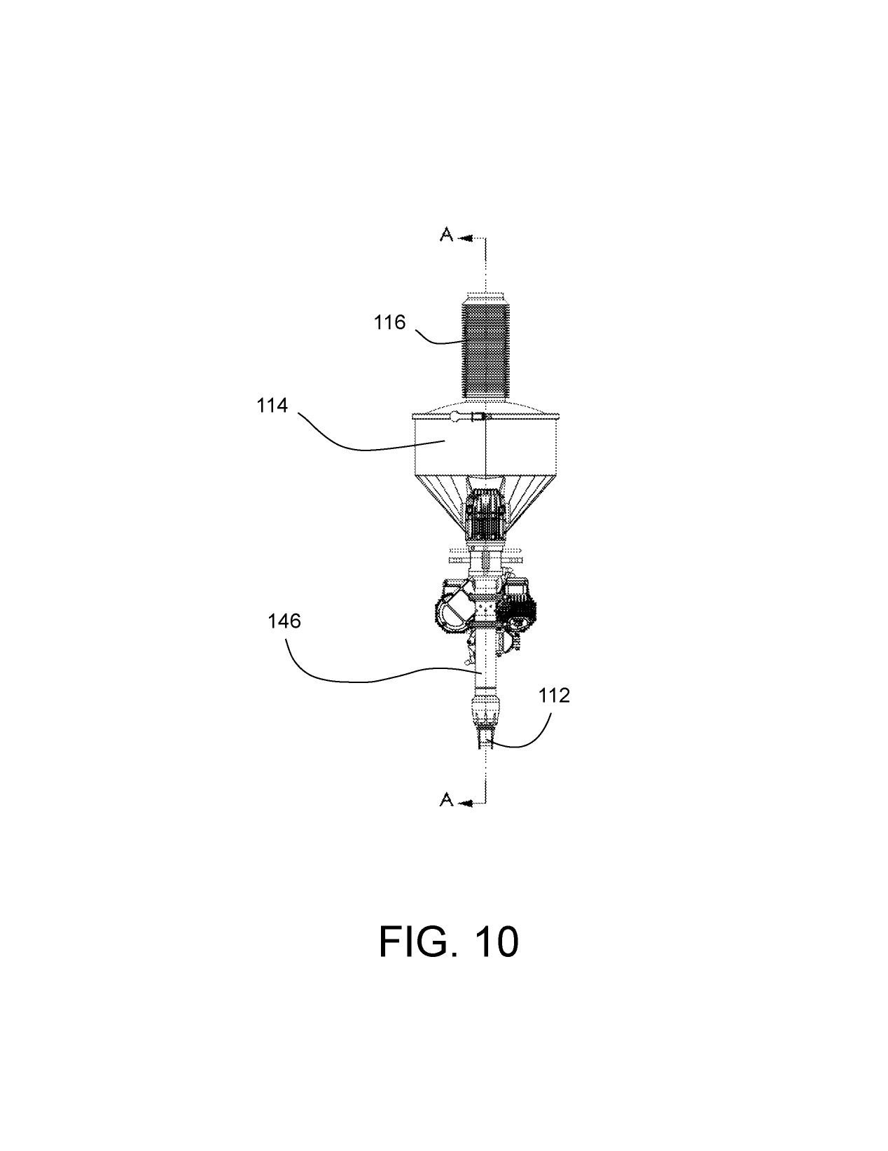

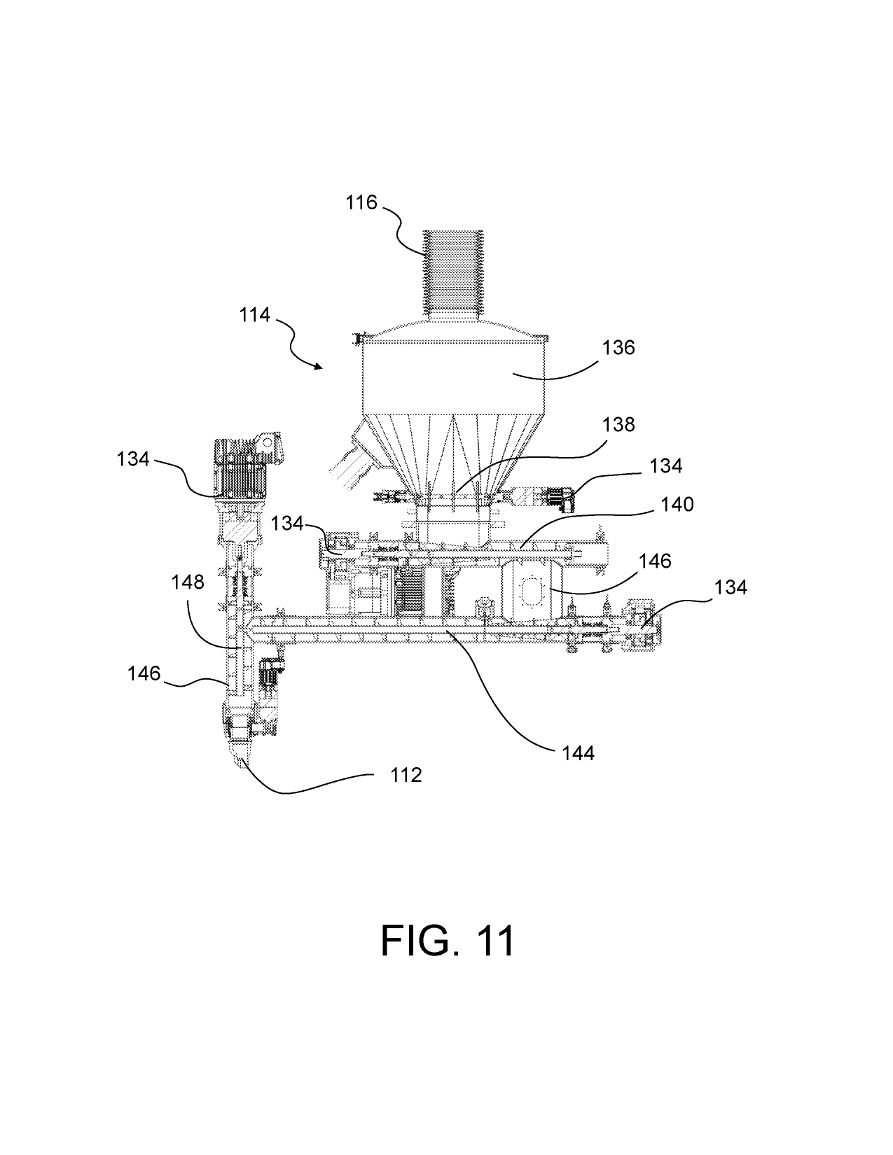

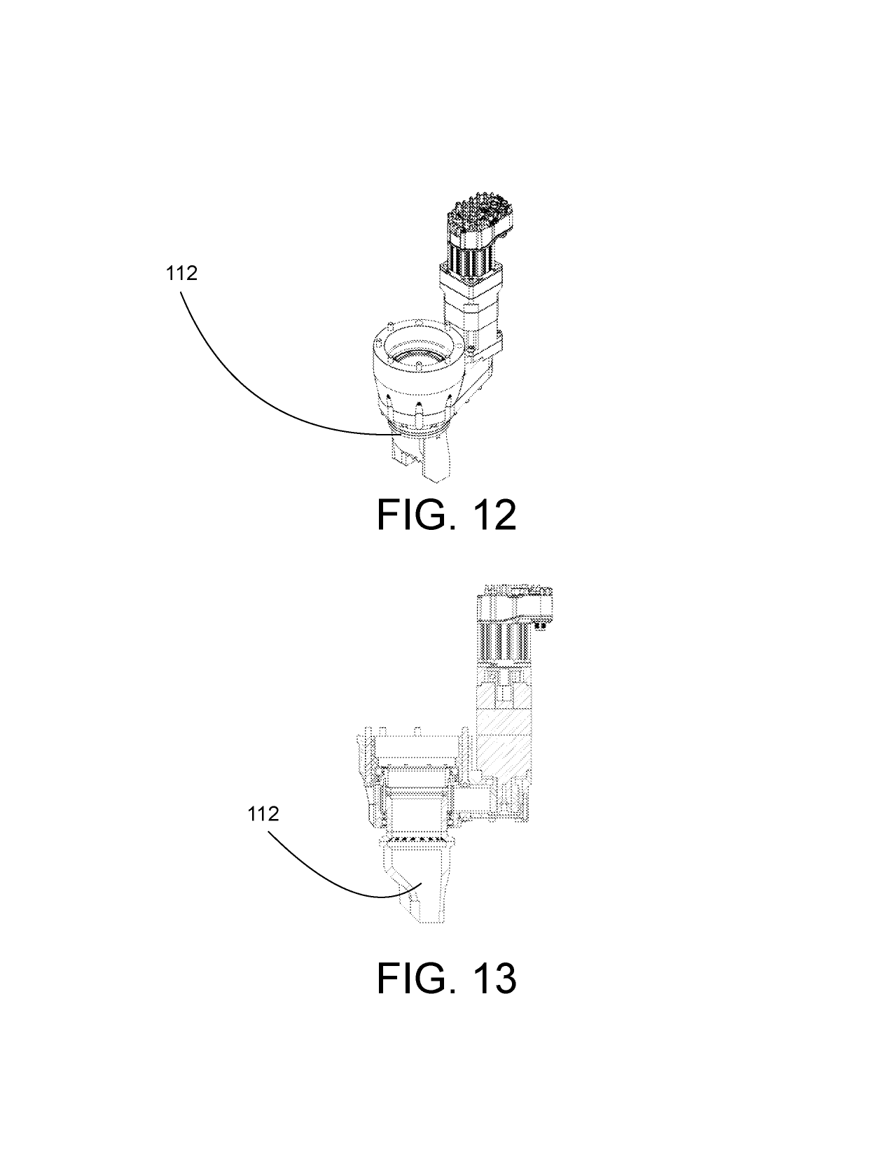

FIG. 10 illustrates a front view of a mixer head 114, a mixer tube 116, a vertical print nozzle shaft 146, and a print nozzle 112 forming a material mixing and extrusion assembly, with a sectional line A–A indicating a cross-sectional view (shown in FIG. 11) taken through the assembly.

FIG. 11 illustrates a cross-sectional view of the mixer head 114, mixer tube 116, and print nozzle 112 taken along section line A–A of FIG. 10, further illustrating a mixing chamber 136, a mixer 138, a first auger 140, a second auger 144, a vertical print nozzle shaft 146, and a third auger 148 arranged to convey and mix construction material from the mixing chamber 136 toward the print nozzle 112, the augers being driven by one or more hydraulic motors 134.

FIG. 12 illustrates an isometric view of a print nozzle 112 forming a removable nozzle assembly of the print head, the print nozzle 112 being configured for selective attachment and detachment from the material mixing and extrusion assembly.

FIG. 13 illustrates a cross-sectional view of the print nozzle 112 forming the nozzle assembly of the print head and defining an internal flow passage configured to shape and direct printable material during extrusion.

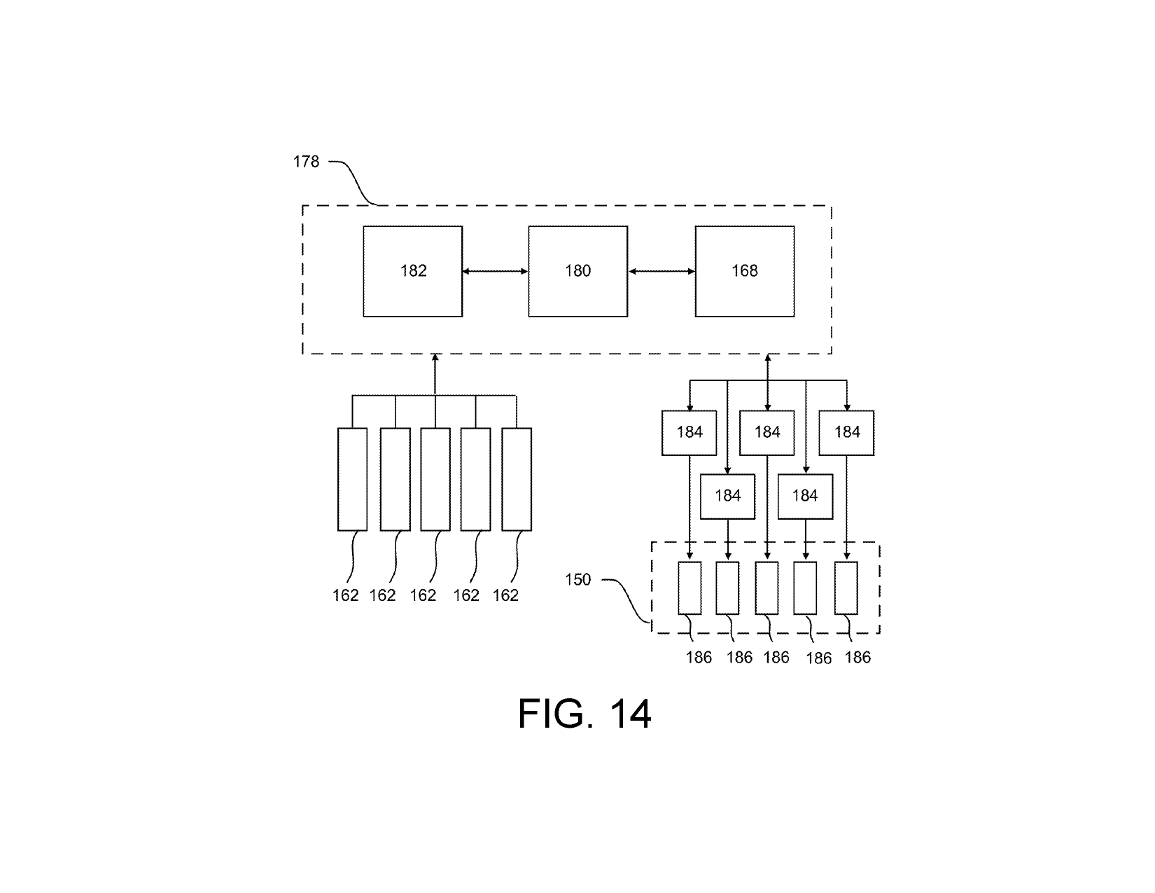

FIG. 14 illustrates a block diagram of the control system 178, showing a programmable logic controller 180 operatively coupled to a motion controller 168 and a communication interface 182, wherein the control system 178 communicates with a plurality of position feedback sensors 162 through a controller area network (CAN) bus 190 and generates coordinated kinematic commands that are transmitted to hydraulic valves 184 for controlling hydraulic actuators 186 of the three-dimensional construction printing system 100 in closed-loop multi-axis motion control. In this embodiment, the control system 178 is operatively coupled to the motion control system 150, whereby the motion control system 150 coordinates feedback from the position feedback sensors 162 with execution of kinematic commands by the motion controller 168 to control the azimuth rotation axis 170, boom extension axis 172, boom elevation axis 174, and payload leveling axis 176.

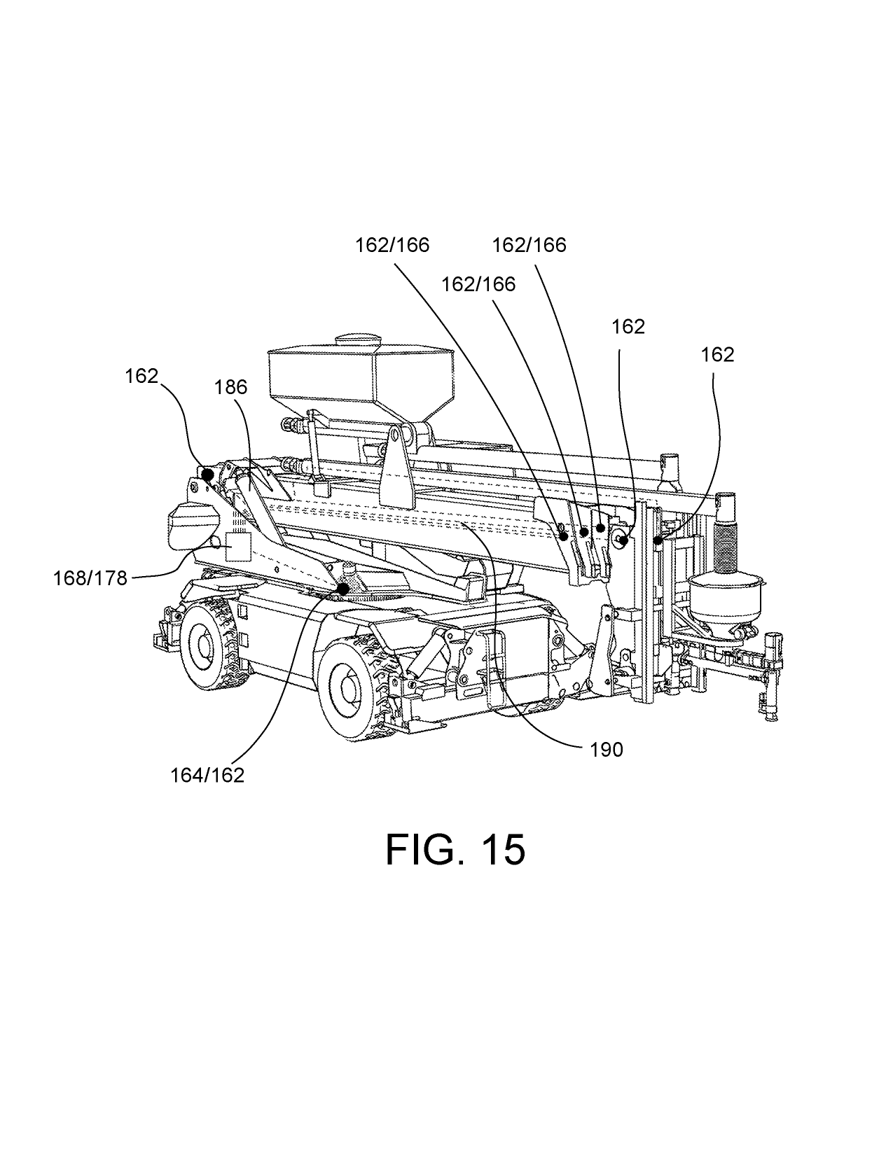

FIG. 15 illustrates a conceptual view of sensor placement on the three-dimensional construction printing system 100, showing exemplary locations of position feedback sensors 162 disposed on the telescoping boom 108, the payload and print head assembly, and the azimuth rotation axis of the base platform 102. In some embodiments, a plurality of linear displacement transducers 166 are disposed along the telescoping boom 108 to detect extension and retraction of the boom. One or more encoders 164 are disposed proximate a boom hinge and a distal end of the boom to detect angular position of the boom and payload. An additional encoder 164 may be disposed on the rotatable superstructure 106 to detect azimuth rotation of the base platform. The position feedback sensors 162 are operatively coupled to a control system 178 and motion controller 168 through a communication network 190. A hydraulic actuator 186 is coupled between the rotatable superstructure 106 and the telescoping boom 108 to effect controlled elevation of the boom. In use, the control system 178 receives feedback from the position feedback sensors 162 and generates control commands for closed-loop multi-axis positioning of the print nozzle relative to a structure.

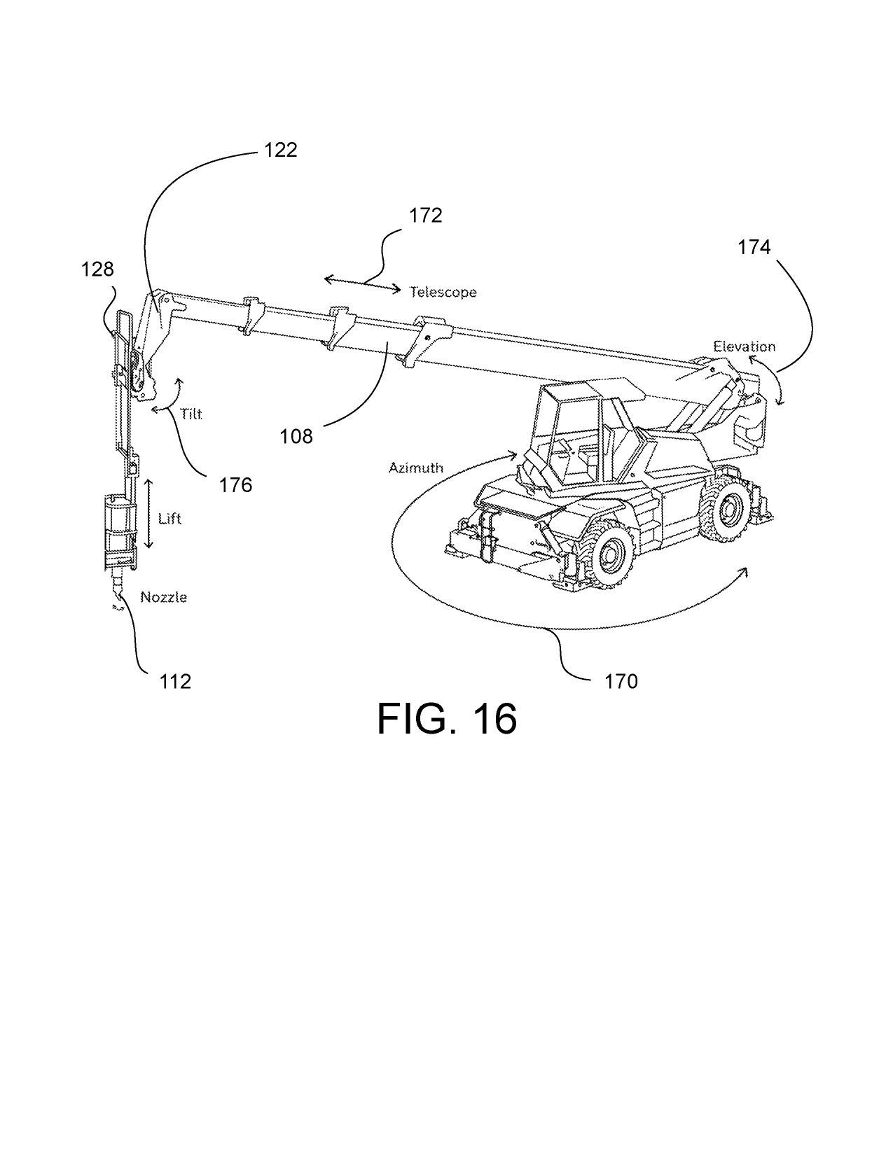

FIG. 16 illustrates a front isometric view of the three-dimensional construction printing system 100 illustrating exemplary kinematic degrees of freedom of the base platform and telescoping boom 108, including an azimuth rotation axis 170, a boom extension axis 172, a boom elevation axis 174, and a payload leveling axis 176, for coordinated positioning of the print nozzle 112 relative to a distal end 122 of the boom 108. It should be noted that in some embodiments a vertical adjustment mechanism 128 lowers the print head. This allows the print nozzle 112 to remain close to the structure 300 to disburse print material, regardless of the height of the print surface relative to the angle and distance of the boom 108. However, this mechanism is not required in some embodiments, as the maneuverability of the base platform 102 and remaining kinematic degrees of freedom 170–176 allow the system to continue to operate with only minimal adjustment of the mixer head 114. This is significant because lowering the print head can introduce vibrations in the print nozzle 112, leading to uneven disbursement of material.

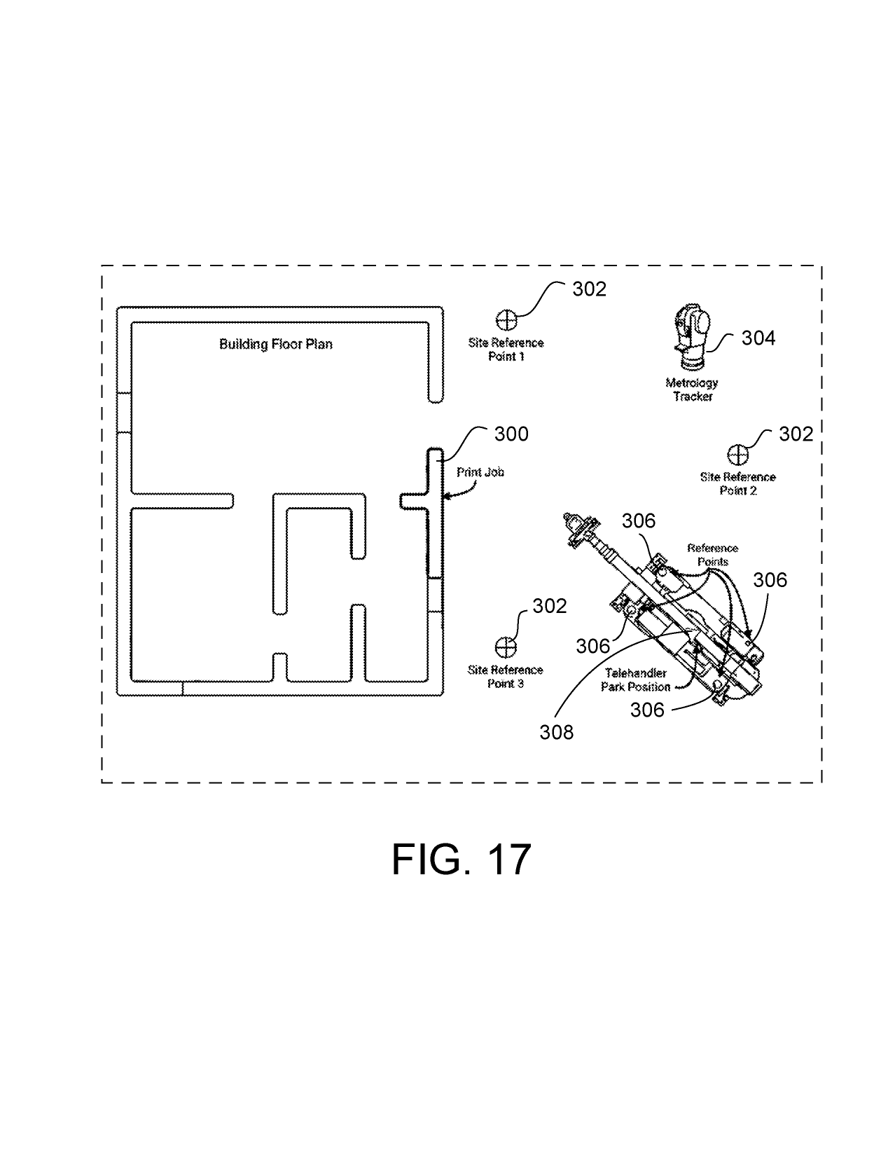

FIG. 17 illustrates a conceptual top plan view of a site plan including a building 300 floor plan and a print job location, further illustrating a plurality of site

reference points 302, a metrology tracker 304, a plurality of telehandler reference points 306, and a telehandler park position 308 for establishing and maintaining positional alignment of the print nozzle relative to the print job. In some embodiments, the metrology tracker 304 is configured to detect positions of the site reference points 302 and the telehandler reference points 306 to establish a coordinate reference frame, whereby a position of the telehandler at the park position 308 is correlated to the site plan 300. In further embodiments, global positioning system (GPS) data is combined with measurements from the metrology tracker 304 to maintain a global and local positional reference, permitting repositioning and resumption of printing with maintained positional fidelity relative to the structure.

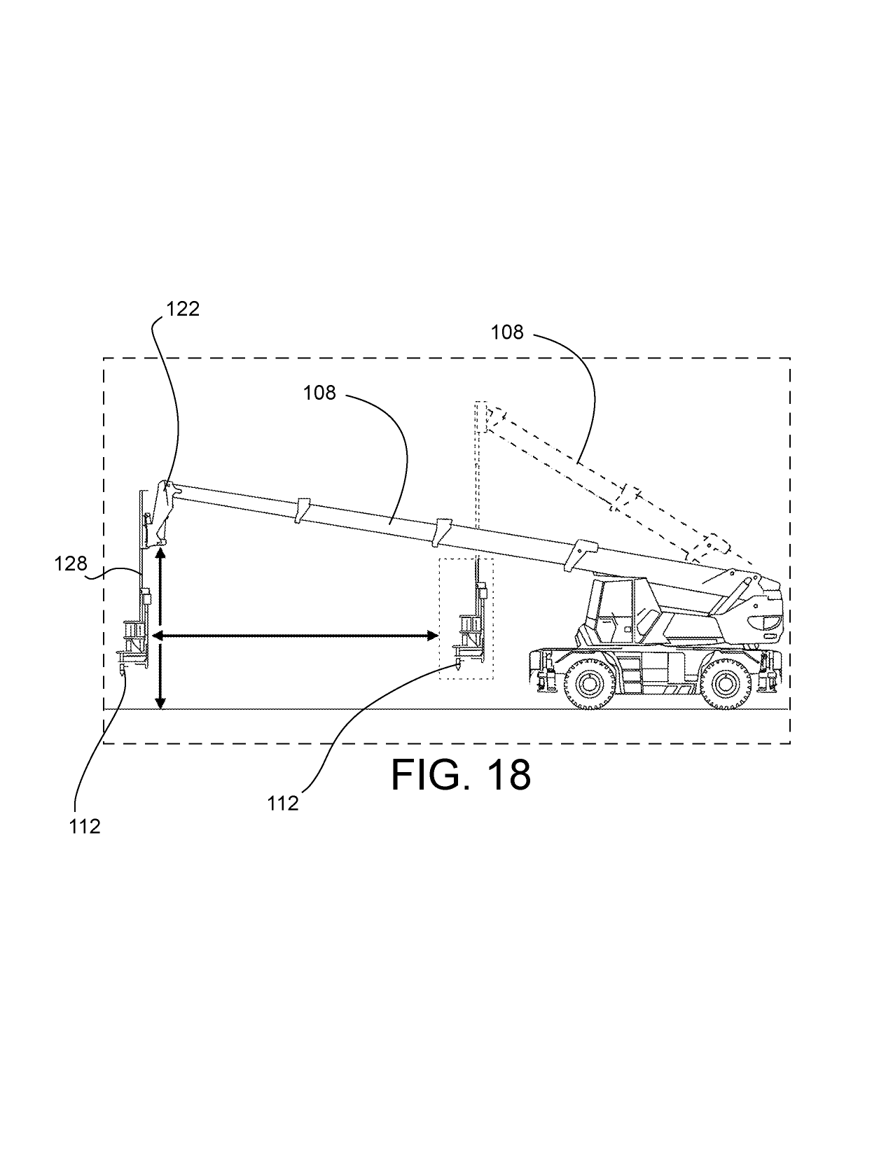

FIG. 18 illustrates a side view of the telescoping boom 108, print nozzle 112, and base platform 102 of the three-dimensional construction printing system 100, with angulated changes of the boom 108 shown in dashed lines to represent alternate boom positions, further illustrating a vertical adjustment mechanism 128 and a printing work envelope within which the print nozzle 112 is positionable relative to a distal end 122 of the boom 108.

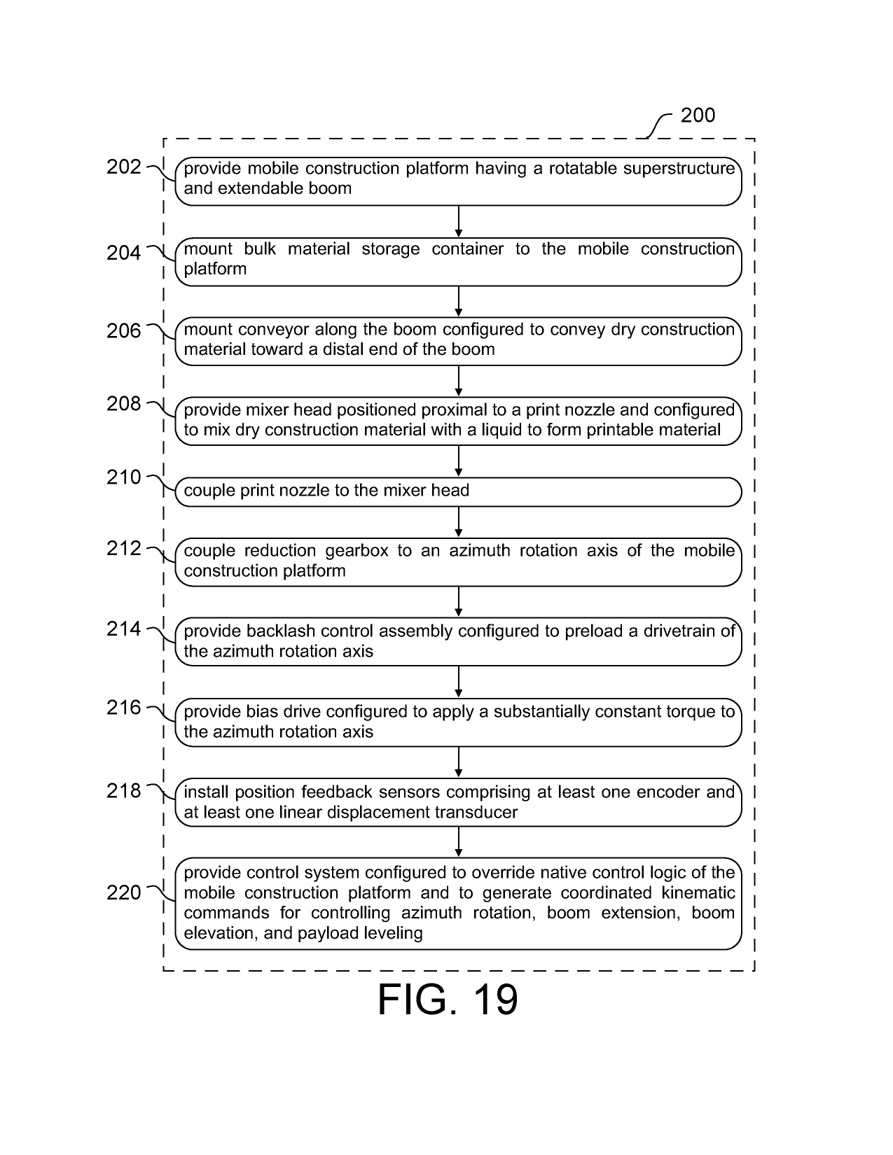

FIG. 19 illustrates a flow diagram of a method 200 of providing a mobile three-dimensional construction printing system.

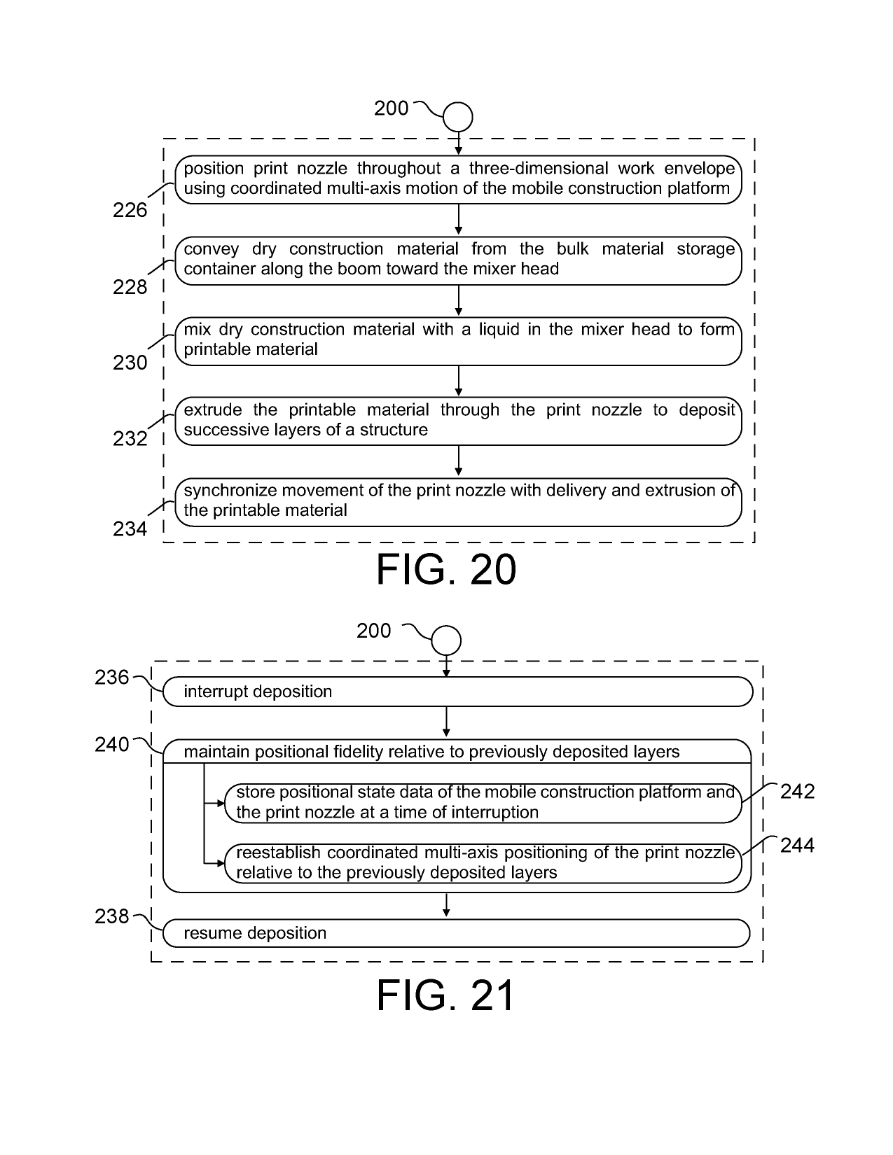

FIG. 20 illustrates a flow diagram of additional steps of the method 200 of providing a mobile three-dimensional construction printing system, further illustrating positioning, conveying, mixing, extruding, and synchronizing operations for depositing successive layers of a structure.

FIG. 21 illustrates a flow diagram of additional steps of the method 200 of providing a mobile three-dimensional construction printing system, further illustrating interrupting deposition, maintaining positional fidelity relative to previously deposited layers, storing positional state data, reestablishing coordinated multi-axis positioning, and resuming deposition.

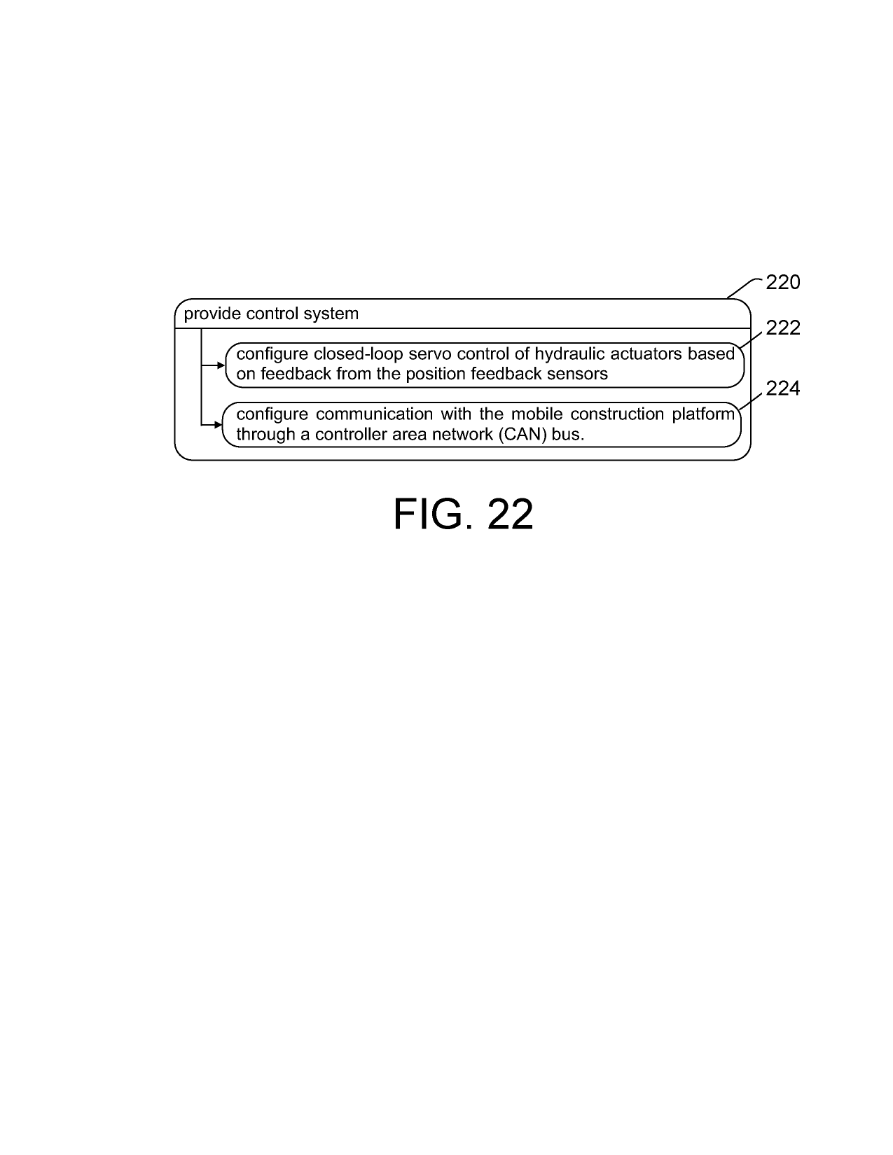

FIG. 22 illustrates a flow diagram of the step 220 of providing a control system in the method 200 of providing a mobile three-dimensional construction printing system, further illustrating configuring closed-loop servo control of hydraulic actuators based on position feedback and configuring communication with the mobile construction platform through a controller area network (CAN) bus.

In an exemplary embodiment, a three-dimensional construction printing system 100 is disclosed. The three-dimensional construction printing system 100 comprises a base platform 102 comprising a construction machine 104 having a rotatable superstructure 106 and a telescoping boom 108, a material delivery assembly 110 mounted to the rotatable superstructure 106 of the base platform 102, and a print nozzle 112 fluidly coupled to the mixer head 114 and configured to extrude the printable material to form successive layers of a structure 300. The material delivery assembly 110 comprises a bulk material storage container 118 configured to store dry construction material, a conveyor 120 extending along the boom 108 and configured to convey the dry construction material from the storage container 118 toward a distal end 122 of the boom 108, and a mixer head 114 positioned proximal to a print nozzle 112 and configured to receive the dry construction material and mix the dry construction material with a liquid to form printable material.

In some embodiments, the conveyor 120 is configured to extend and retract with the boom 108. As may be seen in FIGS. 5-8, the conveyor may comprise multiple segments 124, which continue to provide material delivery regardless of boom 108 length, whereby each segment 124 includes a conveyor track 126 independent in operation of each other conveyor track 126 in the set of multiple segments 124. These segments 124 allow the conveyor 120 to extend and retracts with the boom 108 to maintain a continuous material delivery path independent of boom 108 length.

In some embodiments, the mixer head 114 and print nozzle 112 are mounted to a vertical adjustment mechanism 128, configured to permit said mixer head 114 and print nozzle 112 to raise and lower relative to the distal end 122 of the boom 108 allowing the print nozzle 112 to remain at a consistent elevation relative to the successive layers of a structure 300 despite change in angulation of the boom 108, as may be seen in FIGS. 16-18. The mechanism may include hydraulic actuators to raise and lower securement carriage 132 up and down.

In some embodiments, of three-dimensional construction printing system, the mixer head 114 comprises at least one mixer 138, and at least one auger 140/144/148 driven by a hydraulic motor 134. FIG. 11 shows a cross section of the mixer head 114 and the print nozzle 112 of the mixing system. As shown, the material arrives in the mixing chamber 136, where a mixer 138 rotates and mixes the print material, another auger 140 pulls the material down to a bottom shaft 142, where a third auger 144 pushes the print material into the vertical print nozzle shaft 146. Once in the print nozzle shaft 146, a fourth auger 148 pushes the print material through the print nozzle 112. By the time the print material travels from the mixing chamber 136 to the print nozzle 112, the mixture is prepared to the proper consistency.

In some embodiments, the three-dimensional construction printing system 100 further comprises a motion control system 150 configured to control multi-axis movement of the boom 108 and the print nozzle 112. The motion control system 150 comprises a reduction gearbox 152 coupled to an azimuth rotation axis of the base platform 102, a backlash control assembly 154 configured to preload a drivetrain 156 of the azimuth rotation axis to reduce mechanical slack, a bias drive 158 configured to apply a constant torque to the azimuth rotation axis to maintain gear tooth engagement 160 and suppress oscillation, position feedback sensors 162 comprising at least one encoder 164 and at least one linear displacement transducer 166, and a motion controller 168 configured to generate coordinated kinematic commands for controlling the azimuth rotation axis 170, a boom extension axis 172, a boom elevation axis 174, and a payload leveling axis 176, which may be appreciated from FIG. 16

In some embodiments, the reduction gearbox 152 is configured to provide a gear reduction ratio of at least 20:1 to increase angular resolution of the azimuth rotation axis.

In some embodiments, the backlash control assembly 154 is configured to apply a preload force of between approximately 120 and 150 pounds to the drivetrain, reducing mechanical play during direction reversals of the azimuth rotation axis.

In some embodiments, the bias drive 158 is configured to apply a constant torque of approximately 200 foot-pounds to the azimuth rotation axis to maintain continuous engagement between mating gear teeth of the azimuth rotation axis.

In some embodiments, the position feedback sensors 162 comprise at least one absolute encoder 164 mounted to the azimuth rotation axis and at least one linear displacement transducer coupled to the boom elevation axis.

In some embodiments, the three-dimensional construction printing system 100 further comprises a control system 178 operatively coupled to the motion control system 150. The control system 178 comprises a programmable logic controller 180

configured to convert toolpath instructions into the kinematic commands, and a communication interface configured to transmit control signals to hydraulic valves 184 of the construction machine 104. The control system 178 is configured to synchronize material flow from the material delivery assembly 110 with movement of the boom 108 and the print nozzle 112 to deposit the printable material in a layer-by-layer manner.

In some embodiments, the control system 178 is configured to transmit servo control signals directly to hydraulic valves 184 of the base platform 102.

In some embodiments, the control system 178 is configured to generate coordinated kinematic commands that map desired nozzle motion to joint motions of the azimuth rotation axis 170, boom extension axis 172, boom elevation axis 174, and payload leveling axis 176.

In some embodiments, the control system 178 is configured to synchronize movement of the print nozzle 112 with material delivery and extrusion to maintain substantially constant bead geometry during deposition.

In some embodiments, the control system 178 is configured to store positional state data of the base platform 102 and the print nozzle 112, whereby said positional state data is re-implemented to reestablish coordinated multi-axis positioning of the print nozzle relative to previously deposited layers prior to resuming deposition if the system is interrupted and a reset is required.

In some embodiments, the control system 178 communicates with hydraulic actuators 186 and sensors 162 through a controller area network (CAN) bus 190.

In some embodiments, the control system 178 comprises a programmable logic controller 180 configured to convert toolpath instructions into kinematic commands and a motion controller 168 configured to execute closed-loop servo control of each controlled axis.

In some embodiments, the mixer head 114 comprises a feed auger 148 and a mixer 138 arranged in series. The mixer head 114 is also positioned within a predetermined distance from the print nozzle 112 such that mixing is performed proximal to extrusion to reduce material residence time prior to deposition.

In another exemplary embodiment, a method 200 of providing a mobile three-dimensional construction printing system 100 is disclosed. The method 200 includes providing 202 a mobile construction platform 102 having a rotatable superstructure 106 and an extendable boom 108, mounting 204 a bulk material storage container 118 to the mobile construction platform 102, mounting 206 a conveyor 120 along the boom 108 configured to convey dry construction material toward a distal end 122 of the boom 108, providing 208 a mixer head 114 positioned proximal to a print nozzle 112 and configured to mix dry construction material with a liquid to form printable material, coupling 210 the print nozzle 112 to the mixer head 114, coupling 212 a reduction gearbox 152 to an azimuth rotation axis of the mobile construction platform 102, providing 214 a backlash control assembly 154 configured to preload a drivetrain 156 of the azimuth rotation axis, providing 216 a bias drive 158 configured to apply a substantially constant torque to the azimuth rotation axis, installing 218 position feedback sensors 162 comprising at least one encoder 164 and at least one linear displacement transducer 166, and providing 220 a control system 178 configured to override native control logic of the mobile construction platform 102 and to generate coordinated kinematic commands for controlling azimuth rotation, boom extension, boom elevation, and payload leveling.

In some embodiments, the step of providing 220 the control system 178 further comprises configuring 222 closed-loop servo control of hydraulic actuators 186 based on feedback from the position feedback sensors 162.

In some embodiments, the step of providing 220 the control system 178 further comprises configuring 224 communication with the mobile construction platform 102 through a controller area network (CAN) bus 190.

In some embodiments of the method 200 of providing a mobile three-dimensional construction printing system 100, the method 200 further comprises positioning 226 the print nozzle 112 throughout a three-dimensional work envelope using coordinated multi-axis motion of the mobile construction platform 102, conveying 228 dry construction material from the bulk material storage container 118 along the boom 108 toward the mixer head 114, mixing 230 the dry construction material with a liquid in the mixer head 114 to form printable material, extruding 232 the printable material through the print nozzle 112 to deposit successive layers of a structure, and synchronizing 234 movement of the print nozzle 112 with delivery and extrusion of the printable material.

In some embodiments, the method 200 of providing a mobile three-dimensional construction printing system further comprises the steps of interrupting 236 deposition and subsequently resuming 238 deposition while maintaining 240 positional fidelity relative to previously deposited layers, by storing positional 242 state data of the mobile construction platform and the print nozzle at a time of interruption and reestablishing 244 coordinated multi-axis positioning of the print nozzle relative to the previously deposited layers prior to resuming extrusion.

While there has been shown and described above the preferred embodiment of the instant invention it is to be appreciated that the invention may be embodied otherwise than is herein specifically shown and described and that certain changes may be made in the form and arrangement of the parts without departing from the underlying ideas or principles of this invention as set forth in the Claims appended herewith.

I claim:

1. A three-dimensional construction printing system, comprising:
a base platform comprising a construction machine having a rotatable superstructure and a telescoping boom;
a material delivery assembly mounted to the rotatable superstructure of the base platform and comprising:
a bulk material storage container configured to store dry construction material;
a conveyor extending along the boom and configured to convey the dry construction material from the storage container toward a distal end of the boom; and
a mixer head positioned proximal to a print nozzle and configured to receive the dry construction material and mix the dry construction material with a liquid to form printable material; and
a print nozzle fluidly coupled to the mixer head and configured to extrude the printable material to form successive layers of a structure.

2. The three-dimensional construction printing system, as recited in claim 1, wherein the mixer head comprises at least one auger driven by a hydraulic motor; and
wherein the conveyor is configured to extend and retract with the boom.

3. The three-dimensional construction printing system, as recited in claim 1, wherein the mixer head and print nozzle are mounted to a vertical adjustment mechanism, configured to permit said mixer head and print nozzle to raise and lower relative to the distal end of the boom allowing the print nozzle to remain at a consistent elevation relative to the successive layers of a structure despite change in angulation of the boom.

4. The three-dimensional construction printing system, as recited in claim 1, further comprising:
a motion control system configured to control multi-axis movement of the boom and the print nozzle, the motion control system comprising:
a reduction gearbox coupled to an azimuth rotation axis of the base platform;
a backlash control assembly configured to preload a drivetrain of the azimuth rotation axis to reduce mechanical slack;
a bias drive configured to apply a constant torque to the azimuth rotation axis to maintain gear tooth engagement and suppress oscillation;
position feedback sensors comprising at least one encoder and at least one linear displacement transducer; and
a motion controller configured to generate coordinated kinematic commands for controlling the azimuth rotation axis, a boom extension axis, a boom elevation axis, and a payload leveling axis.

5. The three-dimensional construction printing system, as recited in claim 4, wherein the reduction gearbox is configured to provide a gear reduction ratio of at least 20:1 to increase angular resolution of the azimuth rotation axis.

6. The three-dimensional construction printing system, as recited in claim 4, wherein the backlash control assembly is configured to apply a preload force of between approximately 120 and 150 pounds to the drivetrain, reducing mechanical play during direction reversals of the azimuth rotation axis.

7. The three-dimensional construction printing system, as recited in claim 4, wherein the bias drive is configured to apply a constant torque of approximately 200 foot-pounds to the azimuth rotation axis to maintain continuous engagement between mating gear teeth of the azimuth rotation axis.

8. The three-dimensional construction printing system, as recited in claim 4, wherein the position feedback sensors comprise at least one absolute encoder mounted to the azimuth rotation axis and at least one linear displacement transducer coupled to the boom elevation axis.

9. The three-dimensional construction printing system, as recited in claim 4, further comprising:
a control system operatively coupled to the motion control system, the control system comprising:
a programmable logic controller configured to convert toolpath instructions into the kinematic commands; and
a communication interface configured to transmit control signals to hydraulic valves of the construction machine; and
wherein the control system is configured to synchronize material flow from the material delivery assembly with movement of the boom and the print nozzle to deposit the printable material in a layer-by-layer manner.

10. The three-dimensional construction printing system, as recited in claim 9, wherein the control system is configured to transmit servo control signals directly to hydraulic valves of the base platform.

11. The three-dimensional construction printing system, as recited in claim 9, wherein the control system is configured to generate coordinated kinematic commands that map desired nozzle motion to joint motions of the azimuth rotation axis, boom extension axis, boom elevation axis, and payload leveling axis.

12. The three-dimensional construction printing system, as recited in claim 9, wherein the control system is configured to synchronize movement of the print nozzle with material delivery and extrusion to maintain substantially constant bead geometry during deposition.

13. The three-dimensional construction printing system, as recited in claim 9, wherein the control system is configured to store positional state data of the base platform and the print nozzle, whereby said positional state data is re-implemented to reestablish coordinated multi-axis positioning of the print nozzle relative to previously deposited layers prior to resuming deposition if the system is interrupted and a reset is required.

14. The three-dimensional construction printing system, as recited in claim 9, wherein the control system communicates with hydraulic actuators and sensors through a controller area network (CAN) bus.

15. The three-dimensional construction printing system, as recited in claim 9, wherein the control system comprises a programmable logic controller configured to convert toolpath instructions into kinematic commands and a motion controller configured to execute closed-loop servo control of each controlled axis.

16. The three-dimensional construction printing system, as recited in claim 1, wherein the conveyor extends and retracts with the boom to maintain a continuous material delivery path independent of boom length.

17. The three-dimensional construction printing system, as recited in claim 1, wherein the mixer head comprises a feed auger and a mixer arranged in series; and
wherein the mixer head is positioned within a predetermined distance from the print nozzle such that mixing is performed proximal to extrusion to reduce material residence time prior to deposition.

18. A method of providing a mobile three-dimensional construction printing system, comprising:
providing a mobile construction platform having a rotatable superstructure and an extendable boom;
mounting a bulk material storage container to the mobile construction platform;
mounting a conveyor along the boom configured to convey dry construction material toward a distal end of the boom;
providing a mixer head positioned proximal to a print nozzle and configured to mix dry construction material with a liquid to form printable material;
coupling the print nozzle to the mixer head;
coupling a reduction gearbox to an azimuth rotation axis of the mobile construction platform;
providing a backlash control assembly configured to preload a drivetrain of the azimuth rotation axis;
providing a bias drive configured to apply a substantially constant torque to the azimuth rotation axis;
installing position feedback sensors comprising at least one encoder and at least one linear displacement transducer; and
providing a control system configured to override native control logic of the mobile construction platform and to generate coordinated kinematic commands for controlling azimuth rotation, boom extension, boom elevation, and payload leveling.

19. The method of providing a mobile three-dimensional construction printing system, as recited in claim 18, wherein providing the control system comprises configuring closed-loop servo control of hydraulic actuators based on feedback from the position feedback sensors.

20. The method of providing a mobile three-dimensional construction printing system, as recited in claim 18, wherein providing the control system comprises configuring communication with the mobile construction platform through a controller area network (CAN) bus.

21. The method of providing a mobile three-dimensional construction printing system, as recited in claim 18, further comprising:
positioning the print nozzle throughout a three-dimensional work envelope using coordinated multi-axis motion of the mobile construction platform;
conveying dry construction material from the bulk material storage container along the boom toward the mixer head;
mixing the dry construction material with a liquid in the mixer head to form printable material;
extruding the printable material through the print nozzle to deposit successive layers of a structure; and
synchronizing movement of the print nozzle with delivery and extrusion of the printable material.

22. The method of providing a mobile three-dimensional construction printing system, as recited in claim 18, further comprising:
interrupting deposition and subsequently resuming deposition while maintaining positional fidelity relative to previously deposited layers, by storing positional state data of the mobile construction platform and the print nozzle at a time of interruption and reestablishing coordinated multi-axis positioning of the print nozzle relative to the previously deposited layers prior to resuming extrusion.
